(19) United States
(12) Patent Application Publication
(10) Pub. No.: US 2006/0015610 A1
(43) Pub. Date: Jan. 19, 2006

(54) Gateway architecture for calculating on-line parameters and the method of the same

(76) Inventors: Long Yang, Shanghai (CN); Xiao-Hui Jiang, Shanghai (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/892,850

(22) Filed: Jul. 16, 2004

(51) Int. Cl. G06F 15/173

(52) U.S. Cl. 709/224

(57) ABSTRACT

The present invention provides a gateway for network communication, comprising: a processor and a monitoring means coupled to the processor for accounting on-line time and fee of a network user. A simple network time protocol (SNTP) is coupled to the monitoring means for providing time information. A WAN module is couples to the monitoring means for WAN connection and maintains WAN status information. A data storage is coupled to the monitoring means to save current consumed time and information into the data storage.

### FIELD OF THE INVENTION

This invention relates to an architecture and method of calculating the on-lime parameters including but not limited to time and fee of a network user, and more particularly to a gateway or method with a monitoring means for accounting the on-line parameters of the user.

### BACKGROUND OF THE INVENTION

In recent years, with the progress of the network technology observed mainly as the wide-band of the LAN and the progress of the PC technology by the increasing versatility of computers and the speed of CPUs, it has become possible to transmit the audio and video data between PCs of a plurality of LANs at a high speed to practical use. As requirements for the ability to transfer large amounts of data between computing entities has grown, demand for efficient transfer of the data within and between computing networks has also increased. The global data communication system such as WWW (World Wide Web) has provided acceleration to the spread use of the Internet. The existence of networks for purposes of data communication appears to be a trend of life for the foreseeable future. The transfer of multimedia data including audio, video and image data over the Internet has become commonplace. Data communication is major function of a modern, and it is available over communication networks. Such networks include local area networks (LANS) as well as wide area networks (WANs). The LAN is typically for local communication such as within a small location, building, while the WAN is for communication across a greater distance or even worldwide. Over the past several years various types of networks have allowed network communication between individuals. Therefore, various organizations have created standard techniques to allow communication between host computers on different network. These communication techniques are known as protocols, and are often implemented within each host rather than in the network medium. One considerably prolific network protocol is well known as TCP/IP. An ubiquitous protocol used for transferring data is a Transmission Control Protocol/Internet Protocol (TCP/IP) TCP is described by Postel in Request For Comments (RFC) 793 of the U.S. Defence Advanced Research Projects Agency (DARPA). The TCP is an abbreviation for transport control protocol and the IP is an abbreviation for internetwork protocol. The TCP protocol is closer to the application level and the IP protocol is closer to the physical network connection level. Further, TCP/IP is well known and permits packets of information to be sent and received along different types of networks. In any event, the protocol effectively hides the details of network hardware from the user and allows computers on different network types to communicate with one another independent of the network types. The strings of bytes are formed into TCP/IP packets which are transmitted in a TCP/IP network.

One technique for permitting internet communication using IP involves the use of routers. A router is physically connected to two different networks, and which may receive an information packet from a source on one network and communicate it to a destination on the other network. To use the functionality of the router, each host computer on each network is particularly configured at the IP level to communicate with the IP level of the router when communication. When the router receives the encapsulated packet, it recognizes from the multiple levels of IP information that the packet is ultimately intended for a destination host computer on another network. The Web uses hypertext and hypermedia. Hypertext is a subset of hypermedia and refers to computer-based “documents” in which readers move from one place to another in a document, or to another document, in a non-linear manner. To do this, the Web uses client-server architecture, and the computers that maintain Web information are Web servers. The Web servers enable the user to access hypertext and hypermedia information through the Web and the user's computer. (The user's computer is referred to as a client computer of the Web server computers.) The clients send requests to the servers, which react, search and respond. The Web allows client application software to request and receive hypermedia documents (including formatted text, audio, video and graphics) with hypertext link capabilities to other hypermedia documents, from a Web file server.

A data gateway is used for multiple lines, gateway operations are performed by generating separate data streams for each line. By virtue of these technologies, it is possible to rapidly introduce application software and systems for transmitting sounds, which used to be transmitted by the conventional phones, between PCs on the Internet comprising LANs and WANs. Such an Internet-telephony gateway has a gateway function for conversion of the protocol of the telephone network into the protocol of the Internet or vice versa. Also, Web servers can forward client requests for data, that neither the Web client nor the Web server can access directly, to applications called gateways. Using gateways, a Web server can support data types and resources, and access information outside of the Internet. These data types and resources accessed through gateways may not have been conceived of when the Web was created, and may not be part of the Internet. In the process to use a gateway, the Web client collects data and formulates a request, using HTTP, and transmits the request to the Web server with the name of the gateway program to be executed. The server then communicates with the gateway. The gateway reformats the request, if necessary, and transmits it to an information server to be accessed through the gateway. The gateway receives back a response from the information server and reformats that response, if necessary, as an HTML document, which is delivered to the Web server. The Web server forwards the response to the Web client.

A gateway is a way for two software applications to communicate with each other. A gateway allows for communications between two networks that use different protocols, or which use the same protocols but do not otherwise communicate. For example, a gateway may, in effect, translate between two network protocols. For example, if one network uses TCP/EP, but a user wishes to communicate with another network that may use another protocol, then a gateway may convert the traffic back and forth from one set of protocols to the other, as the first network communicates with the second network.

Gateways tend to be specific to particular protocols used on particular networks. For example, the way to convert electronic mail in one network protocol, to a second network protocol, may be quite different from the way that a remote terminal session on one network protocol is to be converted to the second network protocol. Conventional gateways, then, are usually for a specific application from one specific network protocol to another specific network protocol. Hence, conventional gateways are specific to the hardware platform of the two networks, the communication protocols of the two platforms, and specific applications being run. A conventional gateway may be embodied as a software application that is resident on a Web server host, or as a software application resident on a device separate from a Web host. In the latter case, the gateway may communicate with the Web host through the Internet, or directly by other means. Examples of conventional gateways include Gopher, and FTP.

The gateway performs important function as mentioned above. However, these is no any technique allows the gateway to account the on-line time and fee. The present invention is disclosed to meet the requirement of the ISP for calculating the on-line time and fee of a network user.

### SUMMARY OF THE INVENTION

It is an object of some aspects of the present invention to provide a method and apparatus for calculating the on-line parameters such as on-line time and fee, accounting the on-line frequency or time within a certain period, identifying the member class, usage time.

It is a further object of some aspects of the present invention to provide a method and apparatus for calculating the on-line parameters such as on-line time and fee by a gateway, and accounting the on-line frequency or time within a certain period, identifying the member class, usage time by using the same means.

It is another object of some aspects of the present invention to provide a gateway with monitoring means for accounting and calculating the aforementioned on-line parameters used by a network user.

Gateway

The present invention provides a gateway for calculating on-line parameters of a network user comprising: a processor and a monitoring means coupled to the processor for accounting on-line parameters of the network user. A simple network time protocol (SNTP) is coupled to the monitoring means for providing time information. A WAN module is couples to the monitoring means for WAN connection and maintains WAN status information. A data storage is coupled to the monitoring means to save current consumed time and information into the data storage. The data storage includes Flash memory.

The gateway further comprises a syslog client coupled to the monitoring means to send log message to inform user the message including an expected usage time has been used up and total online time of the current month. A SMTP module (Simple Mail Transfer Protocol) is connected to the monitoring means to transfer the message including an expected usage time has been used up and total online time of the current month by email. A customer configure online monitor module is also coupled to the monitoring means, wherein the customer configure online monitor module may display status message to a customer through the network.

Network with Gate Way to Calculate the On-Line Parameters

The present invention also provides a network with a gateway for calculating parameters, for example on-line time and fee, accounting the on-line frequency or time within a certain period, identifying the member class, usage time, of a network user, the network comprises: an ISP (internet service provider) coupled to the network, wherein the ISP including a router coupled to the network, and a server coupled to an access server of the ISP. A user's terminal device is coupled to the access server through a gateway via WAN (wire area network); wherein the gate way includes a processor. A monitoring means is coupled to the processor for accounting time and fee of a network user and a simple network time protocol (SNTP) is coupled to the monitoring means for fetching time information. A WAN module couples to the monitoring means for WAN connection and maintains WAN status information, and data storage is coupled to the monitoring means to save current consumed time and information into the data storage.

Method to Calculate

A method to calculate the fee of network user, comprising:

fetching network status information of the user by a gateway, wherein the gateway includes a monitoring means for accounting time and fee of the network user;

fetching the current time used by the user in the network status information;

updating and saving the network status information;

determining a usage time of the network user and wherein, when the usage time excesses an expected time, the gateway calculating the excesses time; and

calculating an extra fee for the exceed expected usage time.

The method comprises the step of allowing the network user to receive a message via an interface by a popup window. A step of the method may forbid a new WAN connection when the expected usage time has been used up by the network user. Further, the method comprises a step of determining whether or not it is a new month beginning and a step of resetting statistical information of a past month.

Method to Calculate an On-Line Fee

The present invention discloses a method to calculate an on-line fee of network user, comprising:

providing a gateway includes a monitoring means for accounting time and fee of the network user;

fetching network status information of the network user by the gateway; and calculating the on-line fee.

The method further comprises after calculation or before fetching network status information:

updating and saving the network status information;

determining a usage time of the network user and wherein, when the usage time excesses an expected time, the gateway calculating the excesses time; and

calculating an extra fee for the exceed expected usage time.

The method allows the network user to receive a message via an interface by a popup window. The ISP may forbid a new WAN connection when the expected usage time has been used up by the network user.

The method further comprises steps of:

determining whether or not it is a new month beginning?

resetting statistical information of the past month.

The method further comprises a step of sending message to inform the network user a message. The message includes an expected usage time and total online time of the current month by a syslog client module or by a SMTP module (Simple Mail Transfer Protocol) connected to the monitoring means by email.

The present invention will be more fully understood from the following detailed description of the preferred embodiments thereof, taken together with the drawings, in which:

### BRIEF DESCRIPTION OF THE DRAWINGS

FIG. 1 which is a schematic diagram illustrating transferring data between an Internet Service Provider in a TCP/IP network and a the network user through a gateway connected in the network;

FIG. 2 is a diagram illustrating a major modules of the gateway with a monitoring means according to a preferred embodiment of the present invention;

FIG. 3 is a diagram illustrating a sequence of calculating the on-line time and fee of the network user by a gateway with a monitoring means according to a preferred embodiment of the present invention; and

### DETAILED DESCRIPTION OF PREFERRED EMBODIMENTS

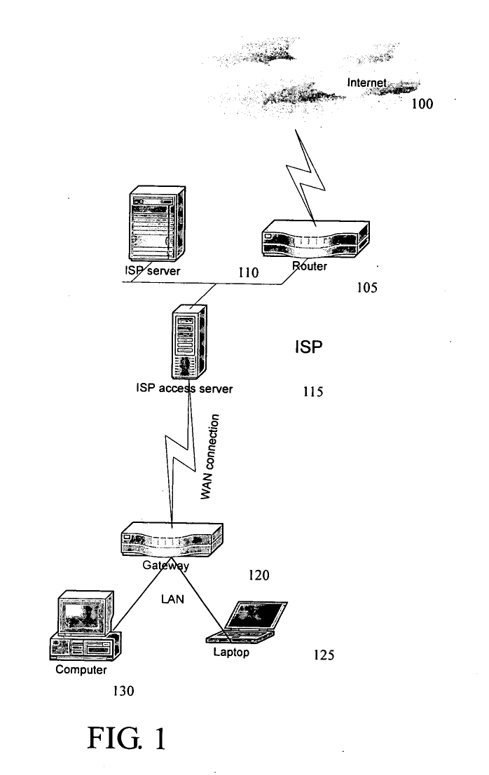

Reference is now made to FIG. 1, which is a schematic diagram illustrating a typical system for transferring data between an Internet 100 and a computer terminal of a user. An internet network 100 operating under a Transmission Control Protocol/Internet Protocol (TCP/IP) comprises one or more generally similar hosts, which may be any host which operates according to a SCSI protocol. An ISP (internet service provider) is coupled to the network. The ISP as know in the art includes a router 105 coupled to the network 100, and at least one of hosts or servers 110. The server 110 of the ISP includes, as well known in the art, memories, CUP, application program and engineers. Both of the router 105 and the server 110 are respectively coupled to an access server 115 of the ISP. The user's terminal device such as the laptop computer 125 or desktop computer 130 is respectively coupled to the access server 115 of the ISP through the gateway 120 via WAN (wire area network). The WAN allows the user to communicate across a greater distance. In one embodiment, the laptop computer 125 and desktop computer 130 could be connected for sharing information or communication via LAN (local area network). The LAN is typically for local communication such as within a small location, building. Each ISP transfers data between the users and is able to communicate with other entities within the network. The server and the router operate as known in the art, and may include software, hardware, or a combination of software and hardware therein.

Gate Way Architecture:

The gateway 120 couples network to TCP/IP network, so as to transfer data between the networks. Preferably, gateway 120 acts as a switch within network. Gateway 120 comprises a central processing unit (CPU) and a memory, the memory preferably also comprising one or more buffers wherein data transferred between networks. Memory also comprises a task mapping table and a connection mapping table. Most preferably, at installation of gateway 120, the gateway identifies hosts operative in network. Alternatively, the gateway identifies hosts by any other means known in the art. Gate way is one of the intelligent nodes for the internet, it could connect the different type of LAN or WAN. Gateway is responsible for transmitting and receiving data. It includes database that enables gateway to determine the direction of transmission. The database may update automatically. The present invention suggests that the gateway maybe used to calculate the on-line parameters such as on-line time or on-line fee used by the member or network user, further, it may also accounting the on-line frequency or time within a certain period, identifying the member class and the usage time. The gateway may also calculate the on-line time during the period of heavy traffic of the internet.

However, no product or method provides such function, mechanism to enable the gateway to perform the matter mentioned above. In order to implement this function, a new module is implemented into the gateway and there is no significant modification on original architecture of gateway. The added module includes means that may calculate the on-line parameters such as on-line time or remain time of the user, means for determining the first date of counting.

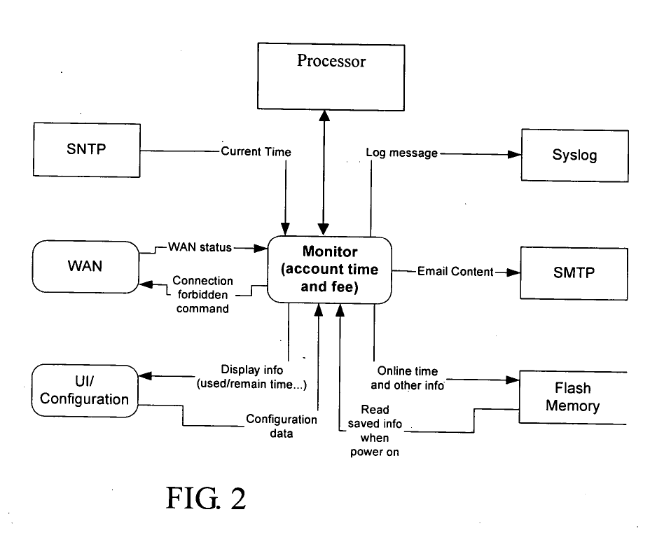

FIG. 2 is a diagram illustrating the functional diagram of the gateway. The gateway includes a monitoring means for accounting on-line time and fee of the network user. A module of Simple Network Time Protocol (SNTP) is coupled to the monitoring means. The gateway may get real time information from the SNTP module. Then the gateway can check the information if a new month begins and to calculate internet online time of a certain user. A Syslog client module is coupled to the monitoring means to send log message to syslog server to inform user the following message includes but not limited to: the expected usage time has been used up; total online time of the current month at the end of the month and other useful information. The expected usage time of each month is referred to the following means: different customer ISP provides different choice for them to connect to Internet. Every choice will have an expected usage time and the corresponding fee for it. If customer consumes more hours than expected usage time, ISP will charge the customer higher charge rate. Further, a SMTP module (Simple Mail Transfer Protocol) is connected to the monitoring means to transfer the same message to customer as SYSLOG but by email. The syslog is a standard protocol for network device to log some important message to syslog server through network. Then customer can refer to syslog server to find what has happened in his network environment. WAN module couples to the monitoring means for WAN connection and maintains WAN status information. The module may allow the gateway to collect the current WAN connection status and to forbid creating new WAN connections when expected usage time has been used up by the consumer. The UI/configuration includes a Customer configure Online Monitor module that is also coupled to the monitoring means and the customer configure online monitor module may display some useful status message to customer through the network. The gateway also includes storage medium, preferably Flash memory for data storage. The customer configure online monitor module needs the memory to save current consumed time in the current month and other useful information into the Flash. Thus, the information can be accessed when power cycled.

Flow Chart of the Method:

If customer does not exceed the expected usage time of this month, he will pay fixed money to ISP. If customer use more hours than expected usage time, the fee for excess minutes will be calculated by using this formula: excess fee=excess minute*fee rate of each excess minute. This new fee rate is higher.

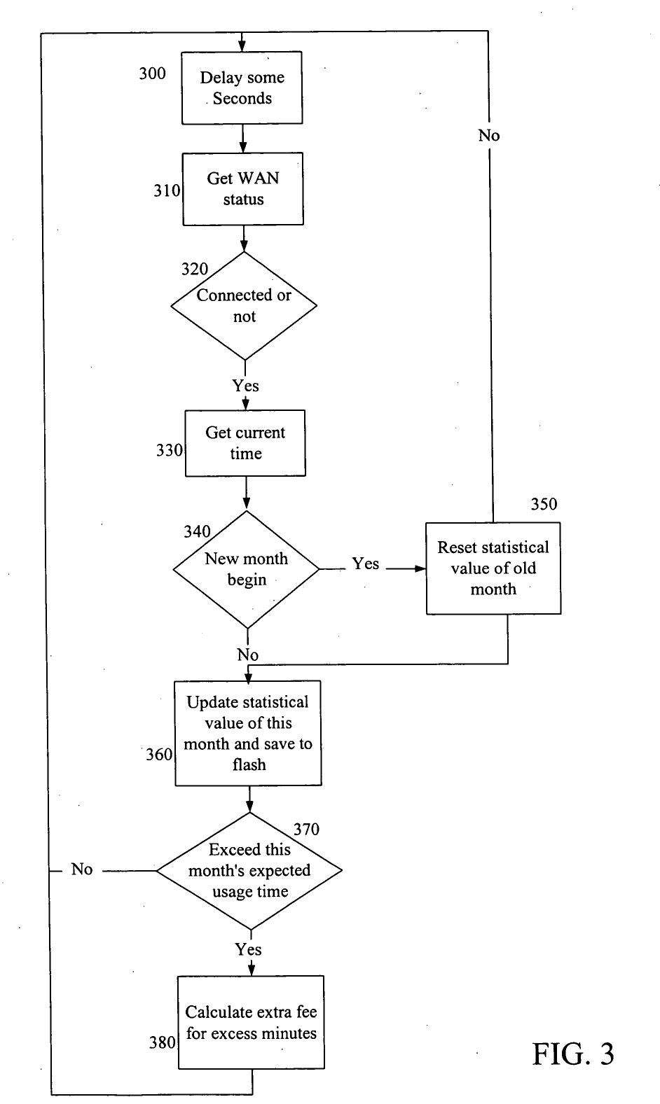

FIG. 3 illustrates the method of the present invention. Those steps in the flow chart will loop forever. Every time it begins to run, it will sleep some seconds at first to release system resource, step 300. The monitoring means connects to the WAN module to access WAN status information, step 310. The gateway may collect the current WAN connection status and to forbid creating new WAN connections when expected usage time has been used up by the consumer. In step 320, the gateway's monitoring means will check the connection is established or not? If the response is negative, the begin from step 300 again. Otherwise, the nest step 330 is to fetch the current time used by the user. Then, the monitoring means will perform the sequence to determine whether or not it is a new month beginning in step 340? If positive, the monitoring means will reset the statistical information of the past month in step 350. If the determination in step 340 is negative, then the module will update the information and save it into the flash memory in step 360. Subsequently, in step 370, the monitoring module determines whether the on-line time used by the user exceeds the expected usage time of the current time or not? If yes, the system will calculate the extra fee for the exceed usage time (380).

The user may receive the message from the ISP by the gateway via the interface by a popup window for one example.

Gateway 120 collects expected usage time message through the monitoring means, and determines whether the expected usage time is exceeded the expected time or not via the WAN module. When gateway 120 receives communication, it reset the information or updates the usage time of the user or calculates the extra fee. Gateway 120 then saves the current information into the memory.

It will be appreciated that the preferred embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

What is claimed is:

1. A gateway for calculating on-line parameter and network communication, comprising:
a processor;
a monitoring means coupled to said processor for accounting said parameter of a network user;
a simple network time protocol (SNTP) coupled to said monitoring means for providing time information;
a WAN module couples to said monitoring means for WAN connection and maintains WAN status information; and
a data storage coupled to said monitoring means to save current consumed time and information into said data storage.

2. The gateway in claim 1, wherein said data storage includes Flash memory.

3. The gateway in claim 1, further comprising a syslog client module coupled to said monitoring means to send log message to inform user the message including an expected usage time has been used up and total online time of the current month.

4. The gateway in claim 1, further comprising a SMTP module (Simple Mail Transfer Protocol) connected to said monitoring means to transfer the message including an expected usage time has been used up and total online time of the current month by email.

5. The gateway in claim 1, further comprising a customer configure online monitor module coupled to said monitoring means, wherein said customer configure online monitor module may display status message to a customer through said network.

6. The gateway in claim 1, wherein said parameter includes on-line time.

7. The gateway in claim 6, further comprising calculating said on-line time during the period of heavy traffic of the internet.

8. The gateway in claim 1, wherein said parameter includes on-line fee.

9. The gateway in claim 1, wherein said parameter includes on-line frequency.

10. The gateway in claim 1, further comprising identifying the member class of a user.

11. A network with a gateway for calculating on-line parameter of a network user, comprising:
a ISP (internet service provider) coupled to said network, wherein said ISP including a router coupled to said network, and a server coupled to an access server of said ISP;
a user's terminal device coupled to said access server through a gateway via WAN (wire area network); wherein said gate way includes a processor;
a monitoring means coupled to said processor for accounting said parameters of said network user;
a simple network time protocol (SNTP) coupled to said monitoring means for fetching time information;
a WAN module couples to said monitoring means for WAN connection and maintains WAN status information; and a data storage coupled to said monitoring means to save current consumed time and information into said data storage.

12. The network in claim 11, wherein said data storage includes Flash memory.

13. The network in claim 11, further comprising a syslog client module coupled to said monitoring means to send log message to inform user the message including an expected usage time that has been used up and total online time of the current month.

14. The network in claim 11, further comprising a SMTP module (Simple Mail Transfer Protocol) connected to said monitoring means to transfer the message including an expected usage time and total online time of the current month by email.

15. The network in claim 11, further comprising a customer configure online monitor module coupled to said monitoring means, wherein said customer configure online monitor module may display status message to a customer through said network.

16. The gateway in claim 11, wherein said parameters includes on-line time.

17. The gateway in claim 16, further comprising calculating said on-line time during the period of heavy traffic of the internet.

18. The gateway in claim 11, wherein said parameters includes on-line fee.

19. The gateway in claim 11, wherein said parameters includes on-line frequency.

20. The gateway in claim 1, further comprising identifying the member class of a user.

21. A method to calculate the on-line time and fee of a network user, comprising:
fetching network status information of said user by a gateway, wherein said gateway includes a monitoring means for accounting said on-line time and fee of said network user;
fetching the current time used by said user in said network status information;
updating and saving said network status information;
determining a usage time of said network user and wherein, when said usage time excesses an expected usage time, then calculating said exceed usage time and calculating an extra fee for said exceed expected usage time.

22. The method in claim 21, further comprising allowing said network user to receive a message via an interface by a popup window.

23. The method in claim 21, further comprising a step of forbidding a new WAN connection when said expected usage time that has been used up by said network user.

24. The method in claim 21, further comprising a step of determining whether or not it is a new month beginning?

25. The method in claim 21, further comprising a step of resetting statistical information of a past month.

26. A method in claim 21, wherein said gateway further comprising:
a processor coupled to said monitoring means;
a simple network time protocol (SNTP) coupled to said monitoring means for providing time information;
a WAN module couples to said monitoring means for network connection and maintains said network status information; and
a data storage coupled to said monitoring means to save current consumed time and information into said data storage.

27. The method in claim 26, wherein said data storage includes Flash memory.

28. The method in claim 26, further comprising a step of sending message to inform said network user a message including an expected usage time that has been used up and total online time of the current month.

29. The method in claim 28, wherein said step of sending message is performed by a syslog client coupled to said monitoring means.

30. The method in claim 28, wherein said step of sending message is performed by a SMTP module (Simple Mail Transfer Protocol) connected to said monitoring means by email.

31. The method in claim 26, further comprising a customer configure online monitor module coupled to said monitoring means, wherein said customer configure online monitor module may display status message to a said network user through said network.

32. A method to calculate an on-line parameter of a network user, comprising:
providing a gateway includes a monitoring means for accounting said on-line parameter of said network user;
fetching network status information of said network user by said gateway; and
calculating said on-line parameter.

33. The method in claim 32, further comprising
updating and saving said network status information; and,
determining a usage time of said network user and wherein, when said usage time excesses an expected usage time, then calculating said exceed usage time and calculating an extra fee for said exceed expected usage time.

34. The method in claim 32, further comprising allowing said network user to receive a message via an interface by a popup window.

35. The method in claim 32, further comprising a step of forbidding a new WAN connection when said expected usage time has been used up by said network user.

36. The method in claim 32, further comprising a step of determining whether or not it is a new month beginning.

37. The method in claim 32, further comprising a step of resetting statistical information of a past month.

38. The gateway in claim 32, wherein said parameter includes on-line time.

39. The gateway in claim 38, further comprising calculating said on-line time during the period of heavy traffic of the internet.

40. The gateway in claim 32, wherein said parameter includes on-line fee.

41. The gateway in claim 32, wherein said parameter includes on-line frequency.

42. The gateway in claim 32, further comprising identifying the member class of a user.

43. A method in claim 32, wherein said gateway further comprising:
a processor coupled to said monitoring means;
a simple network time protocol (SNTP) coupled to said monitoring means for providing time information;
a WAN module couples to said monitoring means for network connection and maintains said network status information; and
a data storage coupled to said monitoring means to save current consumed time and information into said data storage.

44. The method in claim 43, wherein said data storage includes Flash memory.

45. The method in claim 43, further comprising a step of sending message to inform said network user a message including an expected usage time that has been used up and total online time of the current month.

46. The method in claim 45, wherein said step of sending message is performed by a syslog client coupled to said monitoring means.

47. The method in claim 45, wherein said step of sending message is performed by a SMTP module (Simple Mail Transfer Protocol) connected to said monitoring means by email.

48. The method in claim 43, further comprising a customer configure online monitor module coupled to said monitoring means, wherein said customer configure online monitor module may display status message to a said network user through said network.
